(19) United States
(12) Patent Application Publication
(10) Pub. No.: US 2015/0001136 A1
(43) Pub. Date: Jan. 1, 2015

(54) APPARATUS FOR REPAIRING SIFTING OR FILTERING SCREENS

(71) Applicant: M-I DRILLING FLUIDS UK LTD., Aberdeen (GB)

(72) Inventor: Claire Rosaleen Galloway McLean, Granton (GB)

(21) Appl. No.: 14/378,076

(22) PCT Filed: Feb. 8, 2013
(86) PCT No.: PCT/GB2013/050287

§ 371 Date: Aug. 11, 2014

(30) Foreign Application Priority Data
Feb. 9, 2012 (GB) 1202218.2

(51) Int. Cl. B07B 1/46

(52) U.S. Cl. CPC B07B 1/4627; B07B 1/46
USPC 209/391; 29/402.09

(57) ABSTRACT

An apparatus, suitable for use as a plug for a screen frame e.g. as used in the oil and gas drilling industry, comprising a screen frame blocking surface having a first expanded screen frame blocking form, said first form being operatively compressible to form a second compressed form, said second compressed form being operatively returnable to said first expanded form.

### TECHNICAL FIELD

This disclosure relates to an apparatus comprising a screen frame blocking surface, particularly but not exclusively for repairing screens used in the oil drilling industry for separating solids from the liquid phase of oil and water-based muds retrieved from drilling operations.

### BACKGROUND AND PRIOR ART

Sifting screens as used in the oil and gas drilling industry to separate solids from returned drilling muds are commonly comprised of a sheet of sifting material divided into a plurality of cells, often rectangular cells. A common arrangement is for each cell to be defined by the ribs of material extending between opposing regions of the perimeter of such a sifting screen. For example, a rectangular sifting screen would have a plurality of supporting ribs extending orthogonally to create an array of such rectangular cells.

During use, such sifting screens become damaged which can generate holes in them much larger than the gaps between the wire mesh of the sifting screen. This is disadvantageous because it allows solid material to pass through which is larger than desired, reducing the effectiveness of the sifting screen.

Rather than replace the entire sifting screen, which is a costly operation, it is known to place a plug with a snug fit into such a cell, e.g. a rectangular cell, thus sealing the damaged area of sifting screen.

Thus the plug will typically be used in cells which contain a damaged area of screen so as to block the damaged area of screen. Although this does not repair the screen frame in that particular cell, it does have the effect of preventing particles passing through the damaged cell, whilst the remaining cells of the screen continue to function as normal.

Thus, by sealing the damaged areas of the sifting screen, the sifting screen as a whole can continue to function, albeit with a reduced sifting capacity due to the sealed cells. This has the effect of extending the working life of the sifting screen until it has suffered so much damage that the entire screen needs to be replaced.

Such cells are typically formed with protrusions extending from the ribs from which they are formed. Such protrusions are present for the purpose of providing a convenient means for securing such a repair plug in place within the cell. However such protrusions necessarily introduce a constriction in the cell.

Thus, such a plug must firstly pass such a protrusion before it can block the screen material in the cell. Necessarily such a plug must be narrow enough to pass the protrusions, and this therefore means that such plugs are generally not capable of sealing the entire screen mesh within the cell because of their narrow dimension.

U.S. Pat. No. 6,872,466 discloses a method of repairing a damaged sifting or filtering screen having an outer frame across which the filtering mesh is stretched. Within the frame a rectangular grid of ribs divides the filtering area into an orthogonal array of cells. Damage to the mesh is repaired by snap-fitting a plastics plug into the cell underlying the damaged area of the mesh. This repairs the screen by plugging the cell and preventing any particles passing through that cell. However, such known plugs suffer from the disadvantages that they do not always seal adequately against the material of the screen, they do not always snap properly into the desired location and can sometimes fall out of the cell into which they have been placed, in each case this allows some particles to pass through the damaged cell.

Plugs incorporating compressible seals have been proposed to address these problems, see GB 2451263, but such plugs can sometimes fall from the cell they are intended to block. Furthermore, as the screen blocking portion is tapered to allow it to pass the protrusions which eventually hold it in place, these same tapers mean that not all of the sifting screen in that cell is blocked and particles can pass around the perimeter of the seal.

Further improvements in this area are therefore highly desirable.

### SUMMARY OF THE INVENTION

In a first aspect the invention relates to an apparatus comprising a screen frame blocking surface having a first expanded screen frame blocking form, said first form being operatively compressible to form a second compressed form, said second compressed form being operatively returnable to said first expanded form.

Thus the present disclosure provides for the blocking surface itself to have a compressed form to allow the surface to pass such protrusions in screen frame cells, however once the apparatus has passed such protrusions it can return to its first expanded form, whereupon it can provide a complete blocking seal for the cell being repaired.

When it is desired to seal an area of damaged screen, the apparatus according to the disclosure is inserted into the cell containing the damaged area. The apparatus is inserted with the screen frame blocking surface entering the cell first.

The apparatus is then operatively compressed so that the screen blocking surface adopts the second compressed form. This may be by means of a separate insertion tool or by the mere action of pressure induced by the protrusions themselves. For example the screen frame blocking surface can be elastically deformable so that it can deform to its second compressed state as it passes the constriction provided by the protrusions.

Once the apparatus has passed the protrusions the apparatus can be returned to its expanded screen blocking state. This may be by means of a tool inserted to trigger the change in form, or could be achieved by virtue of the apparatus being biased towards the first expanded state and thus returns naturally to the first expanded state after passing the protrusions.

In one preferred embodiment the screen frame blocking surface comprises collapsible terminal regions, said regions being laterally compressible to permit the compression of the frame blocking surface from its first form to its second compressed form. Such collapsible regions can be provided by a region of hollowed elastic material, so that the elastic material can collapse into the hollowed region, easily passing the constriction provided by the protrusions and elastically returning to the expanded state once in place.

In another preferred embodiment the screen frame blocking surface is comprised of at least two hinged portions, said hinged portions being hingedly moveable relative to each other to permit the operative compression of the frame blocking surface from its first form to its second compressed form.

Thus, in a second aspect, the disclosure relates to a method of blocking damaged regions of a sifting or filtering screen, said method comprising the steps of (i) inserting an apparatus according to any of the preceding claims into a region of a filtering screen to be blocked, whilst the screen frame blocking surface is in its second compressed form, (ii) returning said screen frame blocking surface to said expanded first form.

In a further refinement, the apparatus according to the present disclosure further comprises at least one screen frame securing member, said at least one member having a first expanded securing form, said first form being operatively compressible to form a second compressed form, said second compressed form being operatively returnable to said first expanded form. Preferably the second compressed form is biased to return to the first expanded securing form.

In use such a securing member works in a similar way to the screen frame blocking surface. The securing member is adapted to form its second compressed form as this permits it to pass through the constriction provided by the protrusions in the cell.

Once the protrusions are passed, the securing members can be returned to their expanded form, which are adapted to prevent the passage of the apparatus out of the repaired cell by virtue of the engagement of the securing member with the protrusions provided by the cell.

Such a securing member preferably takes the form of an elastically moveable lip, e.g. a lip provided on the end of an elastically moveable arm. The passage past the protrusions would then cause deflection of the arm so it can pass the protrusions, whereupon the elastic arm returns to its first expanded state thus engaging the lip above the protrusion and locking the apparatus in place in a screen blocking orientation above the protrusion.

The apparatus may be made from a variety of materials, however one particularly advantageous feature of the apparatus of the present disclosure is the possibility that it can be made by extrusion.

Thus, in a third aspect, the disclosure relates to a process for the manufacture of an apparatus as described herein, wherein the apparatus is extruded and cut to the dimensions desired.

It has been found that all the required functionality of the present disclosure can be provided by suitable extrusion arrangements. For example, hinges for the flexing of material can be provided by living hinges where the material is thinner to encourage a hinge action. Additionally, more than one material can be extruded, or co-extruded, allowing materials of different material properties, e.g. stiffness, to form different parts of the apparatus. For example a less stiff material could form the collapsible screen frame blocking surface to facilitate its collapsibility whilst the structural components of the apparatus could be made from a stiffer material.

The extruded material may exit the extruder in a continuous manner and such a continuous extrudate could be cut at precisely the desired lengths to create an apparatus according to the present disclosure having a snug fit in the screen frame to be repaired.

The invention will now be illustrated, by way of example, and with reference to the following figures, in which:

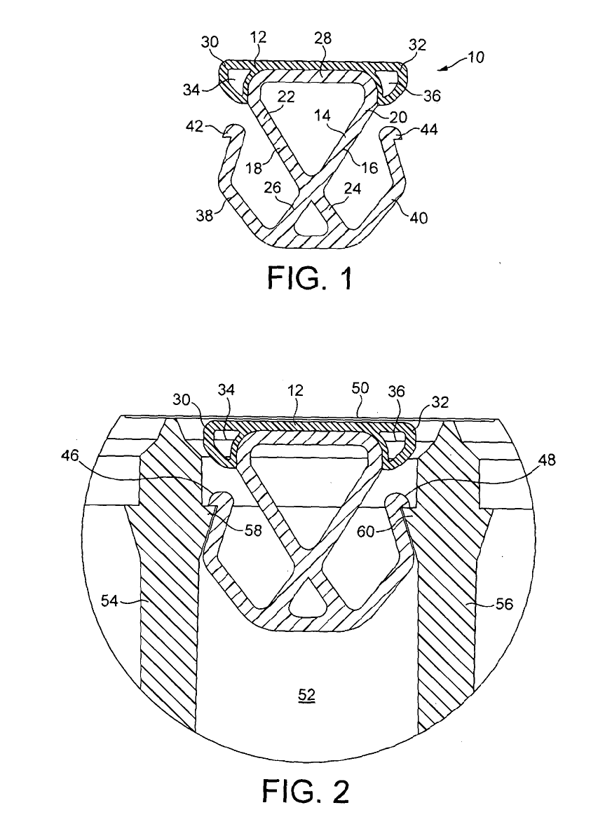

FIG. 1 is a sectional side view of an apparatus according to the disclosure.

FIG. 2 is a sectional side view of the apparatus shown in FIG. 1 in place blocking the screen frame of a cell of a sifting frame.

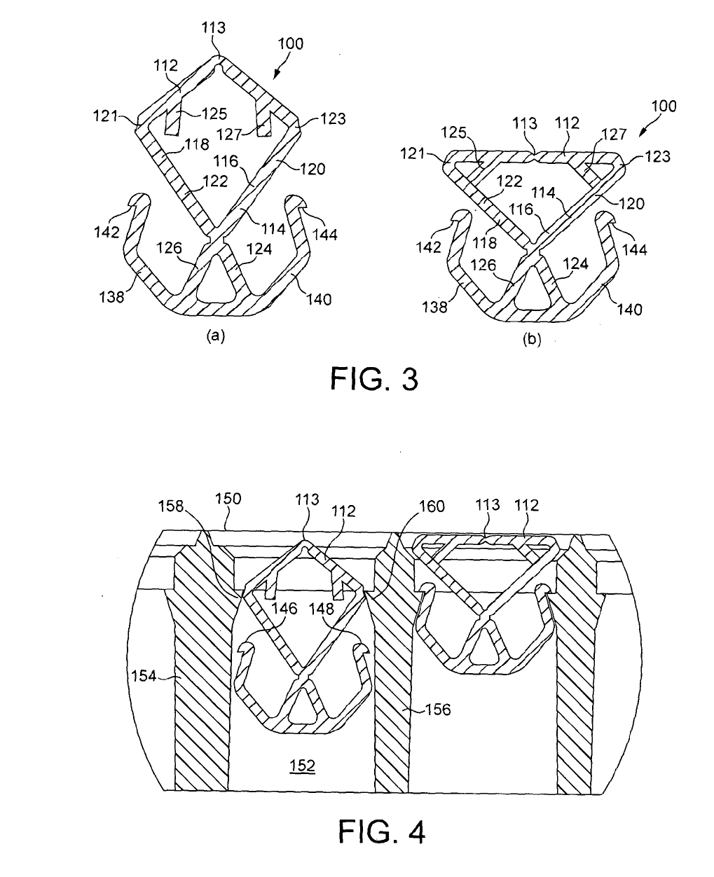

FIG. 3 are sectional side views of another apparatus according to the disclosure, showing it in both its compressed form (FIG. 3a) and its expanded form (FIG. 3b).

FIG. 4 shows sectional side views of the apparatus shown in FIG. 3 as it is inserted into a cell of a sifting frame to be repaired.

Turning to the figures, FIG. 1 shows an apparatus 10 according to the disclosure, commonly referred to as a plug and suitable for repairing a cell of a sifting screen such as those used to separate liquids from solids used in the oil and gas drilling industry.

The apparatus comprises a central frame 14, which is made up of two primary structural members 16, 18 which intersect each other to form upper structural members 20, 22 and lower structural members 24, 26. Connecting the terminal ends of the upper structural members 20, 22 is a blocking surface frame support 28.

Adhered to the blocking surface frame support 28 is a screen frame blocking surface 12. The terminal ends 30, 32 of the screen frame blocking surface 12 can be seen to be seen to form hollow regions 34, 36 within the respective terminal ends 30, 32.

Integrally formed with the central frame 14, and connecting onto lower structural members 24, 26 thereof are two arms 38, 40. At the terminal ends of arms 38, 40 are respective lips 42, 44 which perform the function of securing members, as will now be described.

FIG. 2 shows a screen mesh 50. The mesh is divided into a cell 52 by the presence of two dividing ribs 54, 56. As FIG. 2 is shown as a side sectional view, a further pair of dividing ribs are present but not shown in the figure, said additional ribs being orthogonal to dividing ribs 54, 56 to form a rectangular shape to cell 52. However other shapes of cell can be envisaged such as rhomboid.

Each of ribs 54, 56 comprise protrusions 58, 60 respectively. It can be seen that these protrusions form a constriction in the area of the cell and are intended to hold in place an blocking apparatus, such as one described herein.

In use, cell 52 is in need of repair and it is desired to seal the damaged screen frame 50 which is present within cell 52. An apparatus 10 may then inserted in the orientation shown in FIG. 1 from below. Alternatively the screen frame 50 could be inverted to that orientation shown in FIG. 2 so that the ribs 54, 56 extend above the screen frame surface 50. In this case the apparatus 10 would be inserted from above with the screen frame blocking surface 12 entering the cell 52 first. As can be seen in FIG. 2, the screen frame blocking surface 12 and the securing means 42, 44 both remain in their expanded forms before the apparatus meets the protrusions 58, 60.

Screen frame blocking means 12 is made from a pliable polymeric material, although it could be made from a wide variety of materials, provided it is capable of compression to a compressed form, as will now be described. Additionally, structural frame 14 is also made from a polymeric material, however, this is typically a stiffer material than that used for screen frame blocking surface 12, as it provides structural rigidity to the apparatus 10.

Likewise, arms 38, 40 are made of the same material as that of the structural frame 14 as they are integrally formed, although this need not necessarily be the case.

As the apparatus 10 reaches the protrusions 58, 60 the terminal ends 30, 32 of the screen frame blocking surface 12 begin to enter a constriction created by the protrusions 58, 60. This has the effect of the terminal ends 30, 32 being gradually compressed as the apparatus is inserted and the screen frame blocking surface 12 passes the protrusions 58, 60. The compression is facilitated by the presence of the hollow regions 34, 36 which allow the terminal ends to collapse into the hollowed regions 34, 36. Thus, the screen frame blocking surface 12 is forced to take a second compressed form by the action of the protrusions 58, 60.

Once the screen frame blocking means passes the protrusions 58, 60 the elastic nature of the terminal ends 30, 32 causes them to elastically return to their first expanded form, thus expanding their width to fill the entire cell 52 once again.

Further movement of the apparatus 10 into cell 52 causes the protrusions 58, 60 to meet the upper surfaces 46, 48 of lips 42, 44 respectively. The effect of the constriction caused by the protrusions 58, 60 is to cause the arms 38, 40 to elastically deform inwards to allow the lips 42, 44 to pass the protrusions 58, 60.

As soon as the lips 42, 44 pass the protrusions 58, 60 the elastic nature of the arms 38, 40 causes them to return to their first expanded state. This has the effect of positioning the lips 42, 44 directly above the protrusions 58, 60. The lips therefore now act as securing members locking the apparatus in place and preventing it from leaving the cell 52.

As can also be seen in FIG. 2, the screen frame blocking surface 12 is pressed against sifting screen 50 just at the position when the lips 42, 44 pass the protrusions 58, 60. Thus, the apparatus 10 is held in place by being pressed against the screen frame 50 and held securely by securing means provided by the lips 42, 44.

Thus, the apparatus provides a good quality seal blocking any damaged area of the sifting screen 50 present in the cell 52. Additionally, as the screen frame blocking surface 12 returned to its expanded state after passing the protrusions, it seals a maximum possible area of the screen frame 50.

If it is desired to remove the apparatus 10 from the cell 52 then this can be achieved by inserting a tool and compressing arms 38, 40 so that the securing member in the form of lips 42, 44 can pass freely past protrusions 58, 60 and the apparatus 10 being removed from cell 52.

FIG. 3 shows two views of another apparatus 100 according to the disclosure. In FIG. 3(a) the apparatus 100 is shown in a form in which the screen frame blocking surface is in a compressed form and in FIG. 3(b) it is shown in a form in which the screen frame blocking surface is in an expanded form.

The apparatus comprises a central frame 114, which is made up of two primary structural members 116, 118 which intersect each other to form upper structural members 120, 122 and lower structural members 124, 126. Connecting the terminal ends of the upper structural members 120, 122 is screen frame blocking surface 112.

The terminal ends of upper structural members 120, 122 comprise a respective living hinge 121, 123 which is created by the reduced thickness of material at these locations.

Additionally the centre of the screen frame blocking surface 112 comprises a living hinge 113 again formed by a thinning of the material in that location. Protruding from the lower side of screen frame blocking surface 112 is a pair of detents 125, 127.

Integrally formed with the central frame 114, and connecting onto lower structural members 124, 126 thereof are two arms 138, 140. At the terminal ends of arms 138, 140 are respective lips 142, 144 which perform the function of securing members, as will now be described.

FIG. 4 shows a screen mesh 150. The mesh is divided into a cell 152 by the presence of two dividing ribs 154, 156. As FIG. 4 is shown as a side sectional view, a further pair of dividing ribs are present but not shown in the figure, said additional ribs being orthogonal to dividing ribs 154, 156 to form a rectangular shape to cell 152. However other shapes of cell can be envisaged such as rhomboid.

Each of ribs 154, 156 comprise protrusions 158, 160 respectively. It can be seen that these protrusions form a constriction in the area of the cell and are intended to hold in place a blocking apparatus, such as one described herein.

The entirety of the apparatus 100 is made from the same stiff polymeric material. This can be conveniently manufactured by extruding a polymer or other extrudable material to form the shape shown in FIGS. 3(a) and 3(b). Thus the entirety of apparatus 100 can be made from a single material by extrusion, which is a very convenient form of manufacture.

In use, cell 152 is in need of repair and it is desired to seal the damaged screen frame 150 which is present within cell 152. An apparatus 100 is then inserted in the orientation shown in FIG. 3 from below.

The apparatus 100 could be in the first expanded screen frame blocking form shown in FIG. 3(b) or it could be in the second compressed screen frame blocking form shown in FIG. 3(a). Alternatively it could be in a form part way between these two forms.

As the apparatus 100 reaches the protrusions 158, 160 the living hinges 121, 123 begin to enter a constriction created by the protrusions. This has the effect of the living hinges 121, 123 being forced open. This has the additional effect of forcing the hinge 113 in the sifting screen blocking surface 112 to open, thus causing the sifting screen blocking surface 112 to compress by the action of it folding about the hinge 113. Thus, the screen frame blocking surface 12 is forced to take a second compressed form by the action of the protrusions 158, 160. Once the screen frame blocking means 112 passes the protrusions 158, 160 living hinge 113 begins to meet the screen frame 150. This causes the living hinge 113 to close which has the further effect of causing the sifting screen blocking surface 112 to open out towards its expanded form.

Further movement of the apparatus 100 into cell 152 causes the protrusions 158, 160 to meet the upper surfaces 146, 148 of lips 142, 144 respectively. The effect of the constriction caused by the protrusions 158, 160 is to cause the arms 138, 140 to elastically deform inwards to allow the lips 142, 144 to pass the protrusions 158, 160.

As soon as the lips 142, 144 pass the protrusions 158, 160 the elastic nature of the arms 138, 140 causes them to return to their first expanded state. This has the effect of positioning the lips 142, 144 directly above the protrusions 158, 160. The lips therefore now act as securing members locking the apparatus in place and preventing it from leaving the cell.

As can also be seen in FIG. 4, by the time the lips 142, 144 are locking above protrusions 158, 160 the screen frame blocking surface 112 is pressed flat against sifting screen 150 just at the position when the lips 142, 144 pass the protrusions 158, 160. Additionally detents 125, 127 are now in contact with upper structural members 120, 122.

The detents prevent the screen frame blocking surface from moving away from a horizontal orientation pressed against screen frame 150 whilst locked in place. Thus, the apparatus is held in place by being pressed against the screen frame and held securely by securing means provided by the lips 142, 144.

Thus, the apparatus 100 provides a good quality seal blocking any damaged area of the sifting screen 150 present in the cell 152. Additionally, as the screen frame blocking surface 112 returned to its expanded state after passing the protrusions, it seals a maximum possible area of the screen frame 150.

If it is desired to remove the apparatus 100 from the cell 152 then this can be achieved by inserting a tool and compressing arms 138, 140 so that the securing member in the form of lips 142, 144 can pass freely past protrusions 158, 160 and the apparatus 100 being removed from cell 152.

1. An apparatus comprising a screen frame blocking surface having a first expanded screen frame blocking form, said first form being operatively compressible to form a second compressed form, said second compressed form being operatively returnable to said first expanded form.

2. An apparatus according to claim 1, wherein said screen frame blocking surface is biased to return to its said first expanded form.

3. An apparatus according to claim 1, wherein said screen frame blocking surface is elastically deformable from said first form to said second form.

4. An apparatus according to claim 1, wherein said screen frame blocking surface comprises collapsible terminal regions, said regions being laterally compressible to permit said operative compression of said frame blocking surface from said first form to said second compressed form.

5. An apparatus according to any one of claims 1, wherein said screen frame blocking surface is comprised of at least two binged portions, said hinged portions being hingedly moveable relative to each other to permit said operative compression of said frame blocking surface from said first form to said second compressed form.

6. An apparatus according to claim 1, which further comprises at least one screen frame securing, member, said at least one member having a first expanded securing form, said first form being operatively compressible to form a second compressed form, said second compressed form being operatively returnable to said first expanded form.

7. An apparatus according to claim 6, wherein said second compressed form is biased to return to the first expanded securing form.

8. An apparatus according to claim 7, wherein said securing; member is elastically deformable from said first form to said second form.

9. An apparatus according to claim 6, wherein said securing member comprises a lip of protruding material.

10. An apparatus according to claim 9, wherein said lip is provided on an arm, said arm being hingedly moveable to provide said operative compression from said first securing form to said second compressed form.

11. An apparatus according, to claim 1 which is integrally formed from extruded material.

12. An apparatus according to claim 11, wherein the apparatus is formed from extruded polymeric material.

13. A method of blocking damaged regions of a sifting or filtering screen, said method comprising the steps of:
inserting an apparatus according to any of the preceding claims into a region of a filtering screen to be blocked, whilst the screen frame blocking surface is in its second compressed form,
(ii) returning said screen frame blocking surface to said expanded first form.

14. A process for the manufacture of an apparatus according to claim 1, wherein the apparatus is extruded and cut to the dimensions desired.
